(19) United States
(12) Patent Application Publication
(10) Pub. No.: US 2004/0233315 A1
(43) Pub. Date: Nov. 25, 2004

(54) Image auto-adjusting system and method for digital image capturing apparatus

(75) Inventors: Po-Hsun Lin, Taoyuan (TW); Chao-Lien Tsai, Taoyuan (TW); Hung-Chi Tsai, Taoyuan (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/851,900

(22) Filed: May 20, 2004

(30) Foreign Application Priority Data
May 21, 2003 (TW) 092113778

(51) Int. Cl. H04N 5/222

(52) U.S. Cl. 348/333.01

(57) ABSTRACT

An image auto-adjusting system calibrates digital image capturing apparatuses. An image capturing module of the apparatus adjusts displayed images according to a set of image adjusting variables. The system comprises a adjusting controller built in the apparatus and a light-path channel. The adjusting controller comprises a set of testing image files and a set of corresponding standard image files. The light-path channel enables a light beam of a testing image displayed on a display module to be captured by the image capturing module and to be an captured image file. The adjusting controller controls the testing image file to be displayed as the testing image on the display module, and the testing image is transmitted to the image capturing module via the light-path channel so as to generate the captured image file. The adjusting controller compares the captured image file with the standard image file to adjust the variables.

### BACKGROUND OF THE INVENTION

1. Field of the Invention

The present invention relates to an image auto-adjusting system and method for digital image capturing apparatus, especially the image auto-adjusting system can automatically calibrate the images of a plurality of digital image capturing apparatuses, which are about to leave the factory.

2. Description of the Prior Art

Recently, the market of the digital image capturing apparatus has been expanding; for example, various digital still cameras (DSC) have become available in the market to satisfy market demands. Generally speaking, the brightness and color displayed on an LCD (liquid crystal display) of the same model DSC should be substantially alike. Therefore, the same variables are set to the LCD after each DSC is completed. However, the performance of the LCD of each DSC may not be substantially alike under the same variables. Therefore, the LCD of each DSC should be calibrated before leaving the factory.

The image adjusting of DSC of the prior art is done manually. The variables of each DSC are adjusted one by one before leaving the factory until the brightness and color displayed on the LCD of each DSC is substantially alike. This method consumes not only manpower and time but is also more costly.

Therefore, the objective of the present invention is to provide an image auto-adjusting system and method for digital image capturing apparatus, so as to simplify the adjusting process and time and lower the cost.

### SUMMARY OF THE INVENTION

The objective of the present invention is to provide an image auto-adjusting system and method for digital image capturing apparatus, so that a plurality of digital image capturing apparatus are processed with an image auto-adjusting process to enable the images displayed on each apparatus to be substantially alike.

The present invention provides an image auto-adjusting system for digital image capturing apparatus to calibrate a plurality of digital image capturing apparatus. The digital image capturing apparatus comprises an image capturing module for capturing images, an image display module for displaying images, and an image storage module for storing images. The image display module adjusts the displayed image via at least one set of image adjusting variables. The image auto-adjusting system comprises a adjusting controller and a light-path channel. The adjusting controller is built in the digital image capturing apparatus for controlling image auto-adjusting. The adjusting controller comprises at least one set of testing image files and a set of corresponding standard image files. The light-path channel is used for enabling a light beam of a testing image displayed on the image display module to be captured by the image capturing module via transmission of the light-path channel and stored in the image storage module as an captured image file. The adjusting controller displays the testing image file via the image display module as a testing image, and the testing image is transmitted to the image capturing module via the light-path channel so as to generate the captured image file. The adjusting controller then compares the captured image file with the standard image file to adjust the image adjusting variables.

The image auto-adjusting system and method for digital image capturing apparatus of the present invention provide a adjusting controller and a light-path channel. The adjusting controller comprises at least one set of testing image files and one set of corresponding standard image files. The present invention provides an auto-adjusting that enables the adjusting process of a plurality of digital image capturing apparatus to be simple and fast before leaving the factory, further lowering the cost of production.

The advantage and spirit of the invention may be understood by the following recitations together with the appended drawings.

### BRIEF DESCRIPTION OF THE APPENDED DRAWINGS

FIG. 1 is a schematic diagram of an image auto-adjusting system of a digital image capturing apparatus according to the present invention.

FIG. 2 is a function block diagram of the digital image capturing apparatus shown in FIG. 1.

FIG. 3 is a schematic diagram of that the adjusting controller compares the captured image file with the standard image file shown in FIG. 2.

FIG. 4 is a flowchart of that the adjusting controller calibrates the images shown in FIG. 1 and FIG. 2.

### DETAILED DESCRIPTION OF THE INVENTION

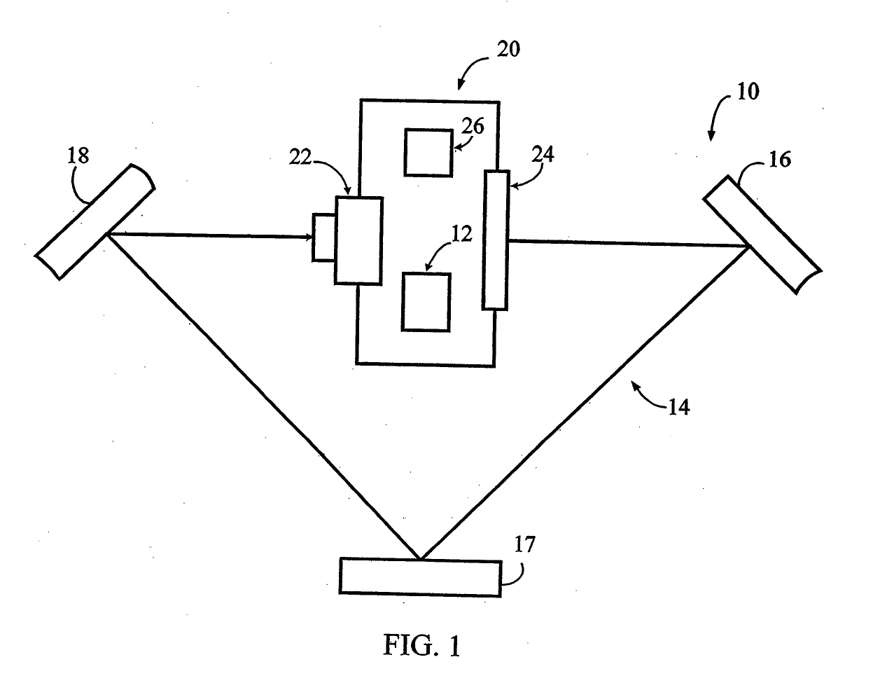

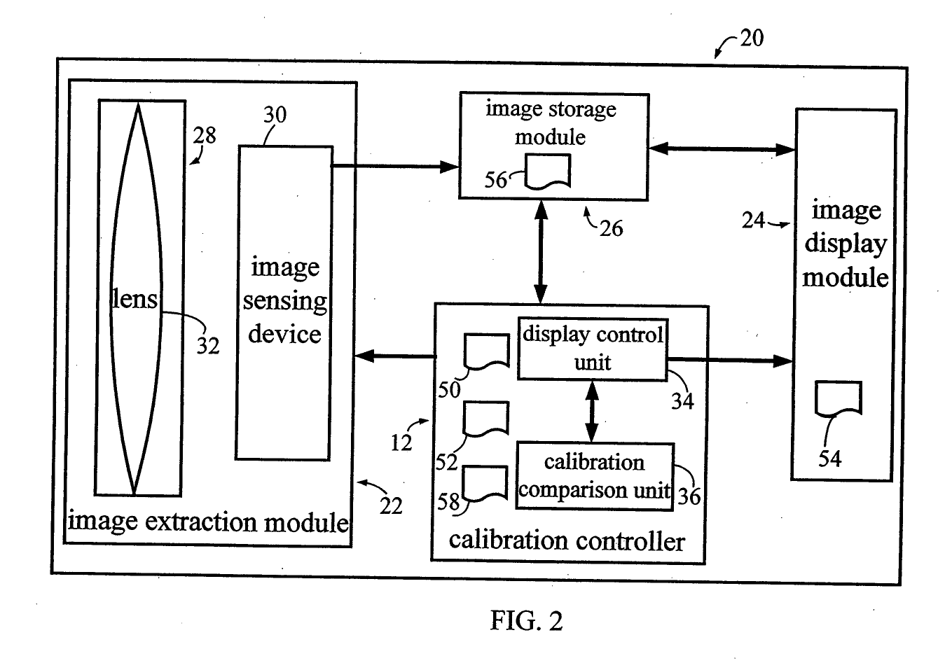

Please refer to FIG. 1 and FIG. 2. FIG. 1 is a schematic diagram of an image auto-adjusting system 10 of a digital image capturing apparatus 20 according to the present invention. FIG. 2 is a function block diagram of the digital image capturing apparatus 20 shown in FIG. 1. The present invention provides an image auto-adjusting system 10 of a digital image capturing apparatus 20 to calibrate a plurality of digital image capturing apparatus. FIG. 1 and FIG. 2 only show one digital image capturing apparatus 20 for the convenience of explanation. The digital image capturing apparatus 20 comprises an image capturing module 22 for extracting images, an image display module 24 for displaying images, and an image storage module 26 for storing images. The image display module 24 adjusts the displayed image via at least a set of image adjusting variables. The digital image capturing apparatus 20 can be a digital still camera (DSC), a digital video camera (DVC), or other similar apparatus. The image display module 24 can be a LCD panel.

The image auto-adjusting system 10 of the present invention comprises a adjusting controller 12 and a light-path channel 14. The adjusting controller 12 is built in the digital image capturing apparatus 20 for controlling image auto-adjusting. The adjusting controller 12 comprises at least one set of testing image files 50 and one set of corresponding standard image files 52. The light-path channel 14 is used for enabling a light beam of a testing image 54 displayed on the image display module 24 to be captured by the image capturing module 22 via transmission of the light-path channel 14 and stored in the image storage module 26 as an captured image file 56. The adjusting controller 12 then compares the captured image file 56 with the standard image file 58 to adjust the image adjusting variables.

As shown in FIG. 1, three reflective mirrors 16, 17, and 18 are configured on the light-path channel 14 for guiding the light beam from the testing image 54 of the image display module 24 to the image capturing module 22.

As shown in FIG. 2, the image capturing module 22 comprises a lens set 28 and an image sensing device 30. The lens set 28 comprises at least one lens 32 for focusing the light beam transmitted via the light-path channel 14 to form the testing image 54. The image sensing device 30 is used for sensing the focused testing image 54 and converting it into the captured image file 56. Therefore, the testing image 54 is guided by the three reflective mirrors 16, 17, and 18, and focused by the lens set 28 to be sensed by the image sensing device 30. The image sensing device 30 is a charged couple device (CCD) sensor, a CMOS (complementary metal-oxide semiconductor) sensor, or other similar device. In other words, the devices, which can achieve the objective of sensing, may be regarded as the image sensing device 30 of the present invention.

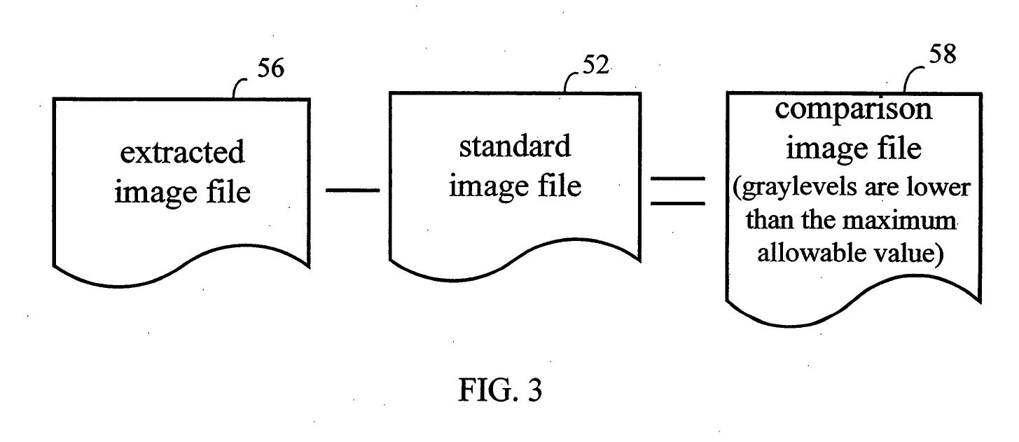

Please refer to FIG. 2 and FIG. 3. FIG. 3 is a schematic diagram of the captured image file 56 being compared with the standard image file 52 by the adjusting controller 12 shown in FIG. 2. As shown in FIG. 2, the adjusting controller 12 is built in the digital image capturing apparatus 20. The adjusting controller 12 displays the testing image file 50 as the testing image 54 through the image display module 24, and the testing image is transmitted to the image capturing module 22 via the light-path channel 14 so as to generate the captured image file 56. The adjusting controller 12 then compares the captured image file 56 with the standard image file 52 to adjust the image adjusting variables.

The adjusting controller 12 comprises a display control unit 34 and an adjusting comparison unit 36. The display control unit 34 is used for controlling the output of the testing image file 50 sent to the image display module 24, so that the image display module 24 displays the testing image file 50 as the corresponding testing image 54 according to the image adjusting variables. The adjusting comparison unit 36 is used for comparing the captured image file 56 with the standard image file 52 and adjusting the image adjusting variables according to an obtained comparison image file 58 after comparison.

The image adjusting method of the adjusting comparison unit 36 will be described as follows. Only a testing image file 50 and a corresponding standard image file 52 are illustrated in this embodiment. The testing image file 50, the captured image file 56, and the standard image file 52 are all in the form of an image matrix; that comprises a plurality of image pixels, wherein each pixel further has a graylevel. As shown in FIG. 3, the adjusting comparison unit 36 performs subtraction on the corresponding graylevels of the pixels of the captured image file 56 and the standard image file 52 to obtain the comparison image file 58. The adjusting comparison unit 36 further adjusts the image adjusting variables according to the comparison image file 58. After that, the image auto-adjusting system 10 iteratively calibrates the current digital image capturing apparatus 20, so that it is adjusted by the image adjusting variables, until the graylevels of the pixels in the comparison image file obtained from each adjusting of the current digital image capturing apparatus 20 are lower than a predetermined maximum allowable value.

The set of testing image files of the adjusting controller 12 comprises a brightness testing image file, a chroma testing image file, a contrast testing image file, a saturation testing image file, and an on screen display (OSD) testing image file. The set of corresponding standard image files comprises a brightness standard image file, a chroma standard image file, a contrast standard image file, a saturation standard image file, and an OSD standard image file. Moreover, the set of corresponding image adjusting variables comprises a brightness image adjusting variable, a chroma image adjusting variable, a contrast adjusting image variable, a saturation image adjusting variable, and an OSD image adjusting variable. Therefore, the adjusting comparison unit 36 adjusts the digital image capturing apparatus 20 in brightness, chroma, contrast, saturation, and OSD one by one. Through the above adjustment process of the image adjusting variables, the graylevels of the pixels in all the comparison image files are lower than a predetermined maximum allowable value. Furthermore, for a plurality of digital image capturing apparatus, the image auto-adjusting system 10 proceeds with the adjusting via the above method, so that the graylevels of the pixels in the comparison image files obtained for the currently calibrated digital image capturing apparatus are all lower than the maximum allowable value, and the images displayed by the image display modules of different digital image capturing apparatus are therefore substantially alike. For example, the image auto-adjusting system 10 can calibrate a plurality of DSCs automatically, so that the images displayed by the image display modules of these digital image capturing apparatuses are substantially alike.

Moreover, about the adjustment of OSD, the digital image capturing apparatus 20 comprises an OSD controller for displaying an OSD menu at a selected position of the image display module 24 according to the OSD image adjusting variables. For example, the OSD menu is displayed in the center of the image display module 24. While adjusting the digital image capturing apparatus 20 with OSD, the adjusting comparison unit 36 individually adjusts the corresponding OSD image adjusting variables, so that the centers of the captured image file and the standard image file are coincident, and the OSD menus of different digital image capturing apparatus are all displayed in the center of the image display modules.

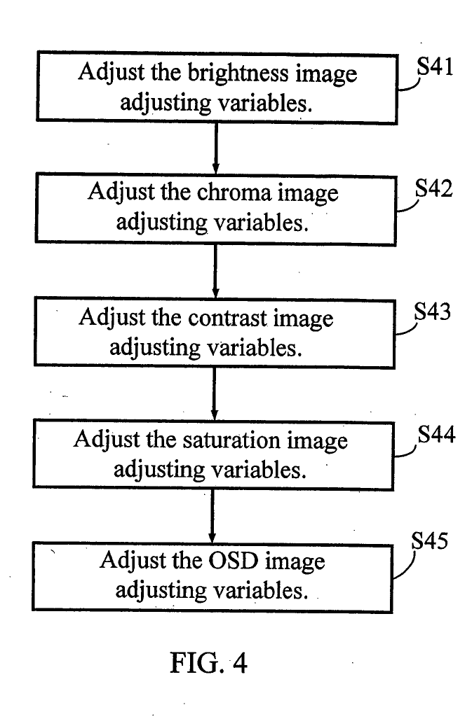

Please refer to FIG. 4. FIG. 4 is a flowchart of how the adjusting controller 12, shown in FIG. 1 and FIG. 2, calibrates images. Please refer to FIG. 1 and FIG. 2 at the same time. An image auto-adjusting method of the digital image capturing apparatus 20, according to the present invention, will be described as follows. First, the testing image file 50 is displayed as a corresponding testing image 54 on the image display module 24. The light beam of the testing image 54 is captured by the image capturing module 22 via the transmission of the light-path channel 14 and stored in the image storage module 26 as an captured image file 56. After that, the captured image file 56 is compared with the standard image file 52 to adjust the image adjusting variables.

As to the auto-adjusting for controlling images by the adjusting controller 12, it adjusts the image adjusting variables, and the process comprises the following steps:

S41: Perform subtraction on the corresponding graylevels of the pixels of the brightness captured image file and the brightness standard image file to obtain a brightness comparison image file. Adjust the brightness image adjusting variables according to the brightness comparison image file until the graylevels of the pixels in the brightness comparison image file are lower than a predetermined maximum allowable value.

S42: Perform subtraction on the corresponding graylevels of the pixels of the chroma captured image file and the chroma standard image file to obtain a chroma comparison image file. Adjust the chroma image adjusting variables according to the chroma comparison image file until the graylevels of the pixels in the chroma comparison image file are lower than a predetermined maximum allowable value.

S43: Perform subtraction on the corresponding graylevels of the pixels of the contrast captured image file and the contrast standard image file to obtain a contrast comparison image file. Adjust the contrast image adjusting variables according to the contrast comparison image file until the graylevels of the pixels in the contrast comparison image file are lower than a predetermined maximum allowable value.

S44: Perform subtraction on the corresponding graylevels of the pixels of the saturation captured image file and the saturation standard image file to obtain a saturation comparison image file. Adjust the saturation image adjusting variables according to the saturation comparison image file until the graylevels of the pixels in the saturation comparison image file are lower than a predetermined maximum allowable value.

S45: Adjust the OSD image adjusting variables according to the OSD captured image file and the OSD standard image file, so that the centers of the OSD captured image file and the OSD standard image file are coincident.

Because the image adjusting of DSC of the prior art is done manually, this way not only consumes manpower, time, and cost but also tends to fall under human subjective judgment, causing inconsistent standard and quality. In comparison with the prior art, the image auto-adjusting system and method utilized in the digital image capturing apparatus of the present invention provides a adjusting controller and a light-path channel. The adjusting controller comprises at least one set of testing image files and a set of corresponding standard image files for calibrating the digital image capturing apparatus automatically, thus avoiding errors from manual inspection in the prior art. The present invention provides an auto-adjusting method that enables the adjusting process of a plurality of digital image capturing apparatus to be simple and fast before leaving the factory, further lowering the cost and achieving more objective and consistent quality requirement.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An image auto-adjusting system utilized in a digital image capturing apparatus to calibrate a plurality of digital image capturing apparatus, the digital image capturing apparatus comprising an image capturing module for extracting images, an image display module for displaying images, and an image storage module for storing images, the image display module adjusting the displayed image via at least a set of image adjusting variables, the image auto-adjusting system comprising:
an adjusting controller built in the digital image capturing apparatus for controlling image auto-adjusting, comprising at least a set of testing image files and a set of corresponding standard image files; and
a light-path channel for enabling a light beam of a testing image displayed on the image display module to be captured by the image capturing module via transmission of the light-path channel and stored in the image storage module to be an captured image file,
wherein, the adjusting controller controls the testing image file to be displayed as the testing image on the image display module, and the testing image is transmitted to the image capturing module via the light-path channel so as to generate the captured image file, and the adjusting controller compares the captured image file with the standard image file to adjust the image adjusting variables.

2. The image auto-adjusting system of claim 1, wherein the adjusting controller comprises:
a display control unit for controlling the output of the testing image file to the image display module, so that the image display module displays the testing image file as the corresponding testing image according to the image adjusting variables; and
an adjusting comparison unit for comparing the captured image file with the standard image file, and adjusting the image adjusting variables according to an obtained comparison image file after comparison.

3. The image auto-adjusting system of claim 2, wherein the testing image file, the captured image file, and the standard image file are all in the form of an image matrix comprising a plurality of image pixels, each pixel further having a graylevel, and wherein the adjusting comparison unit performs subtraction on the graylevels of the pixels of the captured image file and the standard image file to obtain the comparison image file.

4. The image auto-adjusting system of claim 3, wherein after the adjusting comparison unit adjusts the image adjusting variables according to the comparison image file, the image auto-adjusting system iteratively calibrates the current digital image capturing apparatus, so that through the adjustment process of the image adjusting variables, the graylevels of the pixels in the comparison image file obtained from each adjusting for the current digital image capturing apparatus are lower than a predetermined maximum allowable value.

5. The image auto-adjusting system of claim 4, wherein while performing adjusting on the digital image capturing apparatus, the image auto-adjusting system individually adjusts the corresponding image adjusting variables, so that the graylevels of the pixels in the comparison image file obtained for the currently calibrated digital image capturing apparatus are all lower than the maximum allowable value, and the images displayed by the image display modules of different digital image capturing apparatus are substantially alike.

6. The image auto-adjusting system of claim 1, wherein the image capturing module comprises:
a lens set comprising at least a lens for focusing the light beam transmitted via the light-path channel, to form the testing image; and
an image sensing device for sensing the focused testing image and converting the focused testing image to the captured image file.

7. The image auto-adjusting system of claim 6, wherein the image sensing device is a charged couple device (CCD) sensor or a CMOS sensor.

8. The image auto-adjusting system of claim 6, wherein a plurality of reflective mirrors are configured on the light-path channel for guiding the light beam from the testing image of the image display module to the lens set, so as to be sensed by the image sensing device.

9. The image auto-adjusting system of claim 1, wherein the set of testing image files comprises at least one of the following: a brightness testing image file, a chroma testing image file, a contrast testing image file, a saturation testing image file, and an on screen display (OSD) testing image file, and the set of corresponding standard image files comprises at least one of the following: a brightness standard image file, a chroma standard image file, a contrast standard image file, a saturation standard image file, and an OSD standard image file, and the set of corresponding image adjusting variables comprises at least one of the following: a brightness image adjusting variable, a chroma image adjusting variable, a contrast adjusting image variable, a saturation image adjusting variable, and an OSD image adjusting variable.

10. The image auto-adjusting system of claim 9, wherein the digital image capturing apparatus comprises an OSD controller, for displaying an OSD menu at a selected position of the image display module according to the OSD image adjusting variables.

11. The image auto-adjusting system of claim 10, wherein while performing adjusting on the digital image capturing apparatus, the image auto-adjusting system individually adjusts the corresponding OSD image adjusting variables, so that the centers of the captured image file and the standard image file are coincident, and the OSD menus of different digital image capturing apparatus are all displayed in the center of the image display modules.

12. The image auto-adjusting system of claim 1, wherein the digital image capturing apparatus is a digital still camera (DSC) or a digital video camera (DVC).

13. The image auto-adjusting system of claim 1, wherein the image display module is an LCD panel.

14. An image auto-adjusting method utilized in a digital image capturing apparatus to calibrate a plurality of digital image capturing apparatuses, the digital image capturing apparatus being for capturing images and then adjusting the captured image for displaying via at least a set of image adjusting variables, the adjustingmethod comprising:
providing at least a set of testing image files and a set of corresponding standard image files;
displaying the testing image file to be a corresponding testing image;
capturing the testing image;
storing the captured testing image to be a captured image file; and
comparing the captured image file with the standard image file to adjust the image adjusting variables.

15. The image auto-adjusting method of claim 14, wherein the testing image file, the captured image file, and the standard image file are all in the form of an image matrix comprising a plurality of image pixels, and each pixel further has a graylevel, and wherein the method performs subtraction on the graylevels of the pixels of the captured image file and the standard image file to obtain a comparison image file for adjusting the image adjusting variables.

16. The image auto-adjusting method of claim 15, wherein after the method adjusts the image adjusting variables according to the comparison image file, the method iteratively adjusts the current digital image capturing apparatus, so that through the adjustment process of the image adjusting variables, the graylevels of the pixels in the comparison image file obtained from each adjustment for the current digital image capturing apparatus are lower than a predetermined maximum allowable value.

17. The image auto-adjusting method of claim 16, wherein while performing adjustment on the digital image capturing apparatus, the image auto-adjusting method individually adjusts the corresponding image adjusting variables, so that the graylevels of the pixels in the comparison image file obtained for the currently adjusted digital image capturing apparatus are all lower than the maximum allowable value, and the images displayed on different digital image capturing apparatus are substantially alike.

18. The image auto-adjusting method of claim 14, wherein the set of testing image files comprises at least one of the following: a brightness testing image file, a chroma testing image file, a contrast testing image file, a saturation testing image file, and an on screen display (OSD) testing image file, and the set of corresponding standard image files comprises at least one of the following: a brightness standard image file, a chroma standard image file, a contrast standard image file, a saturation standard image file, and an OSD standard image file, and the set of corresponding image adjusting variables comprises at least one of the following: a brightness image adjusting variable, a chroma image adjusting variable, a contrast image adjusting variable, a saturation image adjusting variable, and an OSD image adjusting variable.

19. The image auto-adjusting method of claim 18, wherein the digital image capturing apparatus comprises an OSD controller for displaying an OSD menu at a selected position on an image display module of the digital image capturing apparatus according to the OSD image adjusting variables.

20. The image auto-adjusting method of claim 19, wherein while performing adjusting on the digital image capturing apparatus, the image auto-adjusting method individually adjusts the corresponding OSD image adjusting variables, so that the centers of the captured image file and the standard image file are coincident, and the OSD menus of different digital image capturing apparatus are all displayed in the center of the image display modules.
